(19) United States
(12) Patent Application Publication
(10) Pub. No.: US 2006/0050915 A1
(43) Pub. Date: Mar. 9, 2006

(54) Loudspeaker system with extended output and field cancellation

(75) Inventors: Zeljko Velican, Victoria (AU); Graeme John Huon, Victoria (AU); Walter Melville Dower, Victoria (AU)

Correspondence Address: FOLEY AND LARDNER LLP;SUITE 500, 3000 K STREET NW, WASHINGTON, DC, 20007, US

(73) Assignee: Whise Automotive Pty. Ltd.

(21) Appl. No.: 10/542,031

(22) PCT Filed: Jan. 13, 2004
(86) PCT No.: PCT/AU04/00040

§ 371 Date: Jul. 13, 2005

(30) Foreign Application Priority Data
Jan. 15, 2003 (AU) 2003900164

(51) Int. Cl. H04R 1/02

(52) U.S. Cl. 381/349

(57) ABSTRACT

A loudspeaker system suitable for a confined space includes an electro-acoustic transducer and an enclosure for the electro-acoustic transducer. The enclosure combines a second order topology to produce a rising acoustic response (40) for the system at a second order rate and a helmholtz resonator adapted to modify the rate of rise of the response relative to the second order rate such that the response is attenuated relative to the second order rate but is accentuated relative to a flat response, within a substantial part of a passband of the system at least at a selected frequency or frequencies. The system has means included in an electrical path driving the electro-acoustic transducer for equalizing the rising response to provide extended dynamic headroom at least at the selected frequency or frequencies.

### FIELD OF THE INVENTION

The present invention relates to loudspeaker systems and in particular relates to loudspeaker systems suitable for use in confined spaces such as vehicles.

### BACKGROUND OF THE INVENTION

There has been a trend in recent years to increase sound pressure levels of audio systems used in vehicles and the like as well as to extend frequency range of the systems to provide significant output at relatively low frequencies. The trend has been driven in part by a desire by manufacturers to provide distinguishing product features and by customers who spend a large amount of time in their vehicles and want a better and more realistic sound. A disadvantage of this trend is that it leads to an increase in the level of annoyance to neighbours and the public in general, particularly since low frequencies are difficult to contain and can cause annoyance for a considerable distance outside of a vehicle. The trends also place demands on loudspeaker designs to provide better performance, lower distortion and higher output levels in physically smaller designs.

Prior art approaches to low frequency loudspeaker systems for use in vehicles have placed much emphasis on creating high performance electro-acoustic transducers. The transducers are used in various arrangements including free air mounting and mounting in speaker enclosures in sealed, vented, bandpass or other configurations in an effort to control and augment performance. In these arrangements the electro-acoustic transducer often directly interfaces the listening environment. A problem with systems in which the electro-acoustic transducer directly interfaces the listening environment is that distortion produced by the electro-acoustic transducer determines a limiting value of distortion that may be achieved by the loudspeaker system overall.

It would be desirable to increase sound output without increasing cone displacement or increasing the cone area of the electro-acoustic transducer or increasing the number of electro-acoustic transducers. It would also be desirable to provide a loudspeaker system that can allow enjoyment of loud music inside a confined space such as a vehicle but be relatively quiet outside of that space.

### SUMMARY OF THE INVENTION

The present invention may provide a loudspeaker system suitable for a vehicle. Prior art loudspeaker designs including designs for vehicles have been traditionally based on achieving an acoustically flat frequency response. This has been a significant constraint in loudspeaker design.

The present invention is based on a recognition that program material places higher demands on loudspeakers at some frequencies than at others. Typically the frequencies with the highest demand for music are near the higher frequency end of the sub bass band. With a given amplifier power and enclosure size, sound pressure level of a loudspeaker system may be optimised at selected frequencies by aiming to provide an acoustic response that is not flat. Instead the acoustic response may include a band of rising acoustic response with frequency according to a need for realistic sound reproduction. The acoustic response may contain an accentuated peak at a selected frequency. The acoustic response of an audio system over a desired frequency spectrum may be subsequently adjusted toward a flatter response (ie. neither accentuated nor attenuated) by employing a separate filter in an electrical path driving the loudspeaker system. The filter may include an attenuated dip at the selected frequency such that it at least partly equalizes or attenuates the accentuated peak at the selected frequency.

By utilizing this approach, the loudspeaker may be given additional output or dynamic headroom capability at frequencies where it is most needed and the additional headroom may be achieved within linear excursion limits of the electro-acoustic transducer so that distortion may be controlled. However a side effect of the rising response, that may require care in transducer design, is that distortion may increase at the lower frequency end of the sub bass band.

According to one aspect of the present invention there is provided a loudspeaker system suitable for a confined space including:
an electro-acoustic transducer having a relatively low value of Qt, wherein Qt denotes total quality factor of resonant behaviour of said electro-acoustic transducer, including electrical and mechanical quality factors;
an enclosure having a second order topology for said electro-acoustic transducer which is naturally inclined to produce a rising acoustic response for said system at a second order rate, said enclosure having means adapted to interface said confined space to modify the rate of rise of said response relative to said second order rate such that said response is attenuated relative to said second order rate but is accentuated relative to a substantially flat response, within a substantial part of a passband of said system at least at a selected frequency or frequencies; and
means included in an electrical path driving said electro-acoustic transducer for equalizing said rising response to provide extended dynamic headroom at least at said selected frequency or frequencies.

According to a further aspect of the present invention there is provided a method of extending output of a loudspeaker system suitable for a confined space, said method including:
providing an electro-acoustic transducer having a relatively low value of Qt, wherein Qt denotes total quality factor of resonant behaviour of said electro-acoustic transducer including electrical and mechanical quality factors;
providing an enclosure having a second order topology for said electro-acoustic transducer which is naturally inclined to produce a rising acoustic response for said system at a second order rate;
interfacing said enclosure to said confined space to modify said rising response relative to said second order rate such that said response is attenuated relative to said second order rate but is accentuated relative to a substantially flat response, within a substantial part of a passband of said system at least at a selected frequency or frequencies; and
electrically equalizing said rising response to provide extended dynamic headroom at least at said selected frequency or frequencies.

The second order rate may be substantially 12 dB/octave. The attenuated response may be not more than substantially 9 dB/octave and preferably may be substantially 6 dB/octave.

For the purposes of this document a “second order topology” is one in which the transfer function from the electro-acoustic transducer to the listening position or area in the confined space has a mathematical function with two singularities (poles) in the low frequency response. In practice a second order topology may be achieved either by having a sealed loudspeaker in an open listening environment or by removing the backwave, for example by piping it away or by blocking it with a baffle. In the present invention it may be assumed that the backwave has negligible influence on the response in the listening area so that the response rises at a second order rate except as deliberately modified by a filter interface to the listening area. A “second order rate” is a rate at which the low frequency response of the second order topology is naturally inclined to rise. It is nominally 12 dB/octave.

The resulting audio system may exhibit a substantially correct or equalized response overall. The audio system may be capable of achieving relatively higher sound pressure levels with relatively less distortion. The system may also exhibit improved acoustic headroom at least at the selected frequency or frequencies.

Moreover at least partial cancellation of a sound field outside of the confined space may be achieved by adopting appropriate barrier means between the confined space and the environment outside the space and/or additional means such as an acoustic filter to modify phase and/or amplitude of a backwave generated by the electro-acoustic transducer.

### DESCRIPTION OF THE DRAWINGS

A preferred embodiment of the present invention will now be described with reference to the accompanying drawings wherein:

FIG. 1 shows a prior art equalizer circuit suitable for use with a subwoofer;

FIG. 2 shows in cross section one form of enclosure wherein a backwave is constrained by a solid barrier;

FIG. 3 shows in cross section an alternative enclosure wherein the backwave is constrained by a leaky barrier;

FIG. 4 shows a potential frequency response for a system incorporating principles according to the present invention and utilizing the topology of the enclosure shown in FIG. 2;

FIG. 5 shows a potential frequency response for a system incorporating principles according to the present invention and utilizing the topology of the enclosure shown in FIG. 3; and

FIG. 6 shows in cross section a low profile variant of the enclosure shown in FIG. 3.

### DESCRIPTION OF A PREFERRED EMBODIMENT

The preferred embodiment is described herein with reference to subwoofer applications in vehicles although it is to be understood that it is not thereby limited to such applications.

A subwoofer according to the present invention may include a second order topology enclosure wherein one wall includes an electro-acoustic transducer having a relatively low value of Qt mounted in it. A Qt of less than about 0.3, say 0.2 is desirable for an electro-acoustic transducer with a typical resonant frequency of about 35 Hz. However, as Qt rises with resonant frequency a higher value of Qt may be acceptable for an electro-acoustic transducer having a higher resonant frequency. The enclosure may include a chamber on one side of the electro-acoustic transducer with a port to the vehicle passenger compartment. The chamber and port may be used to create an acoustic filter such as a Helmholtz resonator. The acoustic filter may perform several functions. The acoustic filter may control a rate at which acoustic response of the subwoofer rises in the pass band. The acoustic filter may also filter out-of-band harmonics out of the acoustic response to reduce distortion. One advantage of the port access to the vehicle passenger compartment is that a large volume displacement of the cone of a large electro-acoustic transducer can be transferred to the passenger compartment without a need to cut a large hole in the panelwork of the vehicle.

A backwave barrier means may be provided to exclude from the passenger compartment sound generated from the opposing side of the transducer. The barrier means may be provided in any suitable manner and by any suitable means consistent with the intended application. To provide effective cancellation of an external sound field the barrier means may include a large and acoustically leaky element. In the case of an installation in a sedan vehicle the barrier means may include a wall or walls of a trunk.

In other applications the barrier means may be specially built into a vehicle in the form of a sealed or leaky cavity. Alternatively the barrier means may be formed as a sealed cavity as part of the construction of the subwoofer. This may provide the subwoofer with flexibility to be installed in other vehicles including vans and wagons.

The subwoofer may include means for controlling levels of distortion depending upon the intended application. At one extreme there may be little or no audible distortion. At another extreme calculated levels of distortion may be introduced and may be traded against low frequency extension and/or an improved rate of rise of acoustic response relative to frequency. The means for controlling levels of distortion may include a high frequency filter such as a Helmholtz resonator. The amount of headroom and/or low frequency extension sacrificed also may be controlled.

Acoustic response relative to frequency may be characterised by a continuously rising response at a specific rate over a passband that reaches a designed maximum response near a higher frequency end of the passband. The maximum response may be below, at or above the higher frequency end of the passband. The acoustic response may be further characterised by a transition frequency near a lower frequency end of the passband where the acoustic response may gradually change slope to 12 dB/octave. The exact location of the transition frequency may be dependent upon the intended application. The location of the transition frequency may generally be based on a trade off between mid band headroom and low frequency extension. The transition frequency may be set by a combination of driver parameters including power rating and size and properties of the back wave barrier means. It may be above, at or below the lower frequency end of the pass band.

The rising acoustic output of the subwoofer may be adapted to provide valuable acoustic headroom in a part of the band where it is deemed to be required. A rate of rise of acoustic response relative to frequency may be chosen such that it is consistent with acceptable distortion according to Fielder Masking Curves for a particular noise floor of the intended application. Acoustic response may be corrected by electrical equalization to give an overall flat or substantially flat near-field frequency response over the passband.

It is known in the art that there exists in general a gain at relatively low frequencies around 20-30 Hz in vehicle cabins. This cabin gain is a consequence of acoustic behaviour of the cabin as a resonant structure. This resonant structure is excited by ambient and incidental noise as well as by sounds emanating from the subwoofer. The noise floor at frequencies corresponding to resonance is thus proportionally higher and tracks to mask the benefit of the gain. Accordingly, no attempt is made or recommended to equalise for the cabin gain in a typical vehicle as measured at the listener.

Parameters of the electro-acoustic transducer and in particular its resonant frequency and damping may be chosen such that when the transducer is mounted in the enclosure, acoustic output can be equalized within acceptable amplitude variations across the design frequency band with one or more simple electrical circuits such as a two pole Butterworth filter as is known in the art.

A rising acoustic response of 12 dB/octave associated in the prior art with sealed enclosures is generally seen as a problem to overcome and as far back as 1969, electrical equalisation was used to convert to a flat response, for example refer Russell (U.S. Pat. No. 3,715,501). However, in contrast to the present invention, no account was paid to controlling distortion. Most electrically equalised systems were and still are direct radiating, and some are operating well below speaker resonance and are having to equalise all or a large portion of the response at 12 dB/octave, for example refer Long (U.S. Pat. No. 4,481,662).

In a preferred embodiment of the present invention the equalizing filter may be variable to provide correct alignment in different installations. In a further embodiment the equalizing filter may be combined with an inverter-amplifier that is built into the subwoofer.

If the subwoofer is mounted in a rear parcel shelf of a vehicle and relies on walls of the trunk to provide a backwave barrier, a second acoustic filter may be added on the trunk side of the electro-acoustic transducer to isolate the response from changing conditions such as an open or closed trunk, or a full or empty trunk. This particular configuration may be regarded as an infinite baffle configuration.

In the case of an infinite baffle configuration, a second acoustic filter may also provide a barrier to protect the electro-acoustic transducer from physical damage by goods placed in the trunk. In the case of the infinite baffle configuration a degree of external sound field cancellation will occur, thus reducing noise pollution in the environment. The second acoustic filter may be used to assist in optimising the effect of external sound field cancellation by modifying phase and amplitude of the backwave.

The backwave means barrier should be arranged to provide a substantial barrier to sound wave penetration with no substantial leaks between the trunk and the passenger compartment at least for frequencies in the band of interest.

In prior art there are a number of examples of subwoofers mounted under the rear parcel shelf and one that accesses the passenger compartment via a Helmholtz resonator, eg. Hathaway (U.S. Pat. No. 5,394,478). However Hathaway is based on flat acoustic response from the loudspeaker and fails to seek any improvement in headroom, which is a characterising feature of the present invention.

The system may be wired into the same circuit as other electro-acoustic transducers operating in a different frequency range and electrical filtering may be used to provide a crossover function. In a further embodiment, the amplifier and electrical filtering may be external to the subwoofer construction. In a further embodiment the loudspeaker may be designed to fit a baffle formed by another part of the vehicle such as the dash.

Referring to the drawings:

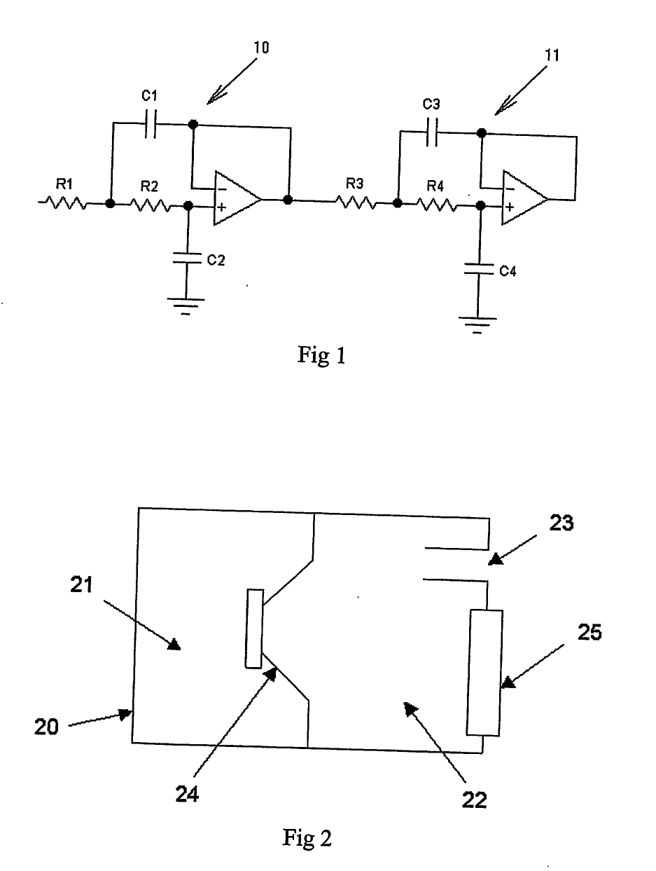

FIG. 1 represents a prior art equaliser circuit suitable for use with a subwoofer. A first filter 10 typically sets a corner frequency at say 20 Hz, and a second filter 11 sets a corner frequency at say 140 Hz.

FIG. 2 represents an example of an enclosure topology in which the backwave is constrained by a solid barrier 20. An amplifier panel 25 may form part of the construction. It is based on a conventional sealed-vented bandpass topology. The uniqueness relates to how it is set up. As an example the enclosed chamber 21 may be say 15 Lt of volume. The front chamber 22 may be say 6 Lt of volume. The port 23 may be say 60 mm diameter by 80 mm long. The electro-acoustic transducer 24 may be say 200 mm diameter and may have a Qt value of approximately 0.2. The topology of FIG. 2 provides a loudspeaker with substantial headroom at the higher frequency end of the sub bass pass band as shown in FIG. 4.

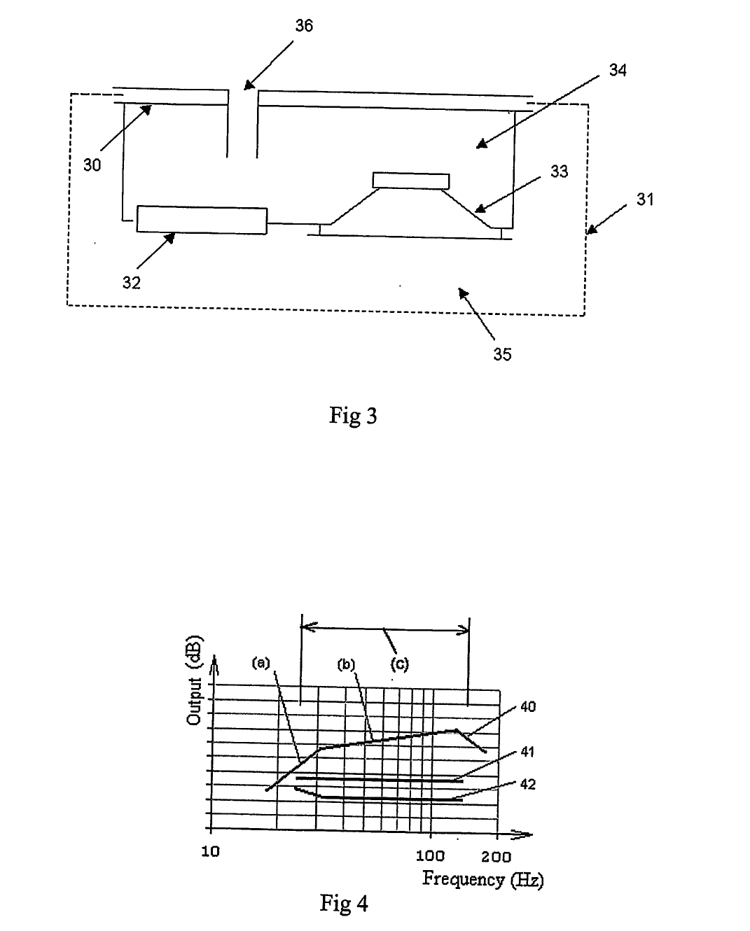

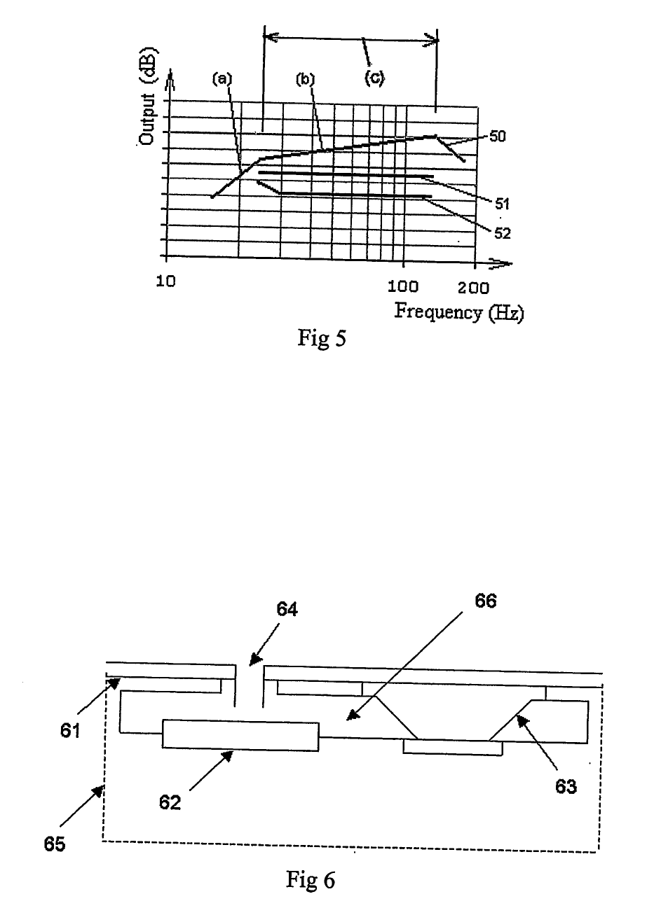

FIG. 3 shows an alternative topology in which the backwave is constrained by a leaky barrier. Panel 30 at the top may represent for example a parcel shelf of the vehicle and doffed line 31 may represent surrounding trunk walls. An amplifier panel 32 may form part of the construction as shown. It may be regarded as a leaky box or an infinite baffle. As an example electro-acoustic transducer 33 may be say 200 mm diameter. The chamber 34 enclosed at the front (towards the listener) may be say 7 Lt. The rear chamber (typically the trunk of a vehicle) 35 may be say 500 Lt. The port 36 may be say 50 mm diameter by say 80 mm long. The Qt value of electro-acoustic transducer 33 may again be relatively low, say 0.2. The topology of FIG. 3 provides a loudspeaker with substantial headroom at the higher frequency end of the sub bass pass band as illustrated in FIG. 5 and also provides a degree of sound field cancellation outside the confined space of the listening area.

FIG. 4 shows the frequency response for an enclosure as shown in FIG. 2. Line 40 at the top represents a typical acoustic response for an unequalised enclosure according to the present invention. At the low frequency end (a) of response 40 the slope is 12 dB/octave and this may extend some way into the pass band (c). In a substantial part of the pass band the slope (b) is substantially modified by the Helmholtz resonator formed by port 23 and chamber 22 in FIG. 2. Line 41 represents an equalised response (near field). Line 42 represents the response at listener position.

FIG. 5 shows the frequency response for an enclosure as shown in FIG. 3. Line 50 at the top represents a typical acoustic response for an unequalised enclosure according to the present invention. At the lower frequency end (a) the slope of response 50 is 12 dB/octave and in this example is outside the pass band (c). In a substantial part of the pass band the slope (b) is substantially modified by the Helmholtz resonator formed by port 36 and chamber 35 in FIG. 3. Line 51 represents an equalised response (near field). Line 52 represents the response at listener position.

FIG. 6 shows a variation of the form of construction represented in FIG. 3 including barrier 61, amplifier panel 62, electro-acoustic transducer 63, port 64, walls 65 and chamber 66. The topology of FIG. 6 provides a loudspeaker with substantial headroom at the higher frequency end of the sub bass pass band and also provides a degree of sound field cancellation outside the confined space. Finally, it is to be understood that various alterations, modifications and/or additions may be introduced into the constructions and arrangements of parts previously described without departing from the spirit or ambit of the invention.

1-38. (canceled)

39. A loudspeaker system suitable for a confined space including:
an electro-acoustic transducer having a relatively low value of Qt, wherein Qt denotes total quality factor of resonant behaviour of said electro-acoustic transducer, including electrical and mechanical quality factors;
an enclosure for said electro-acoustic transducer, said enclosure having a second order topology which is naturally inclined to produce a rising acoustic response for said system at a second order rate, said enclosure further having means adapted to interface said confined space for modifying a rate of rise of said response relative to said second order rate such that said response is attenuated relative to said second order rate but is accentuated relative to a substantially flat response within a substantial part of a passband of said system, said accentuation being most significant at a selected frequency or frequencies near a high end of said passband, said interface means being further arranged to filter harmonics out of said acoustic response to reduce distortion; and
means included in an electrical path driving said electro-acoustic transducer for equalizing said rising response to be substantially flat overall and to provide extended dynamic headroom at least at said selected frequency or frequencies.

40. A loudspeaker system according to claim 39 wherein said second order rate is substantially 12 dB/octave and said attenuated response is not more than substantially 9 dB/octave.

41. A loudspeaker system according to claim 39 wherein said attenuated response is substantially 6 dB/octave.

42. A loudspeaker system according to claim 39 wherein said interface means includes a first acoustic filter.

43. A loudspeaker system according to claim 42 wherein said first acoustic filter includes a helmholtz resonator.

44. A loudspeaker system according to claim 39 wherein said selected frequency or frequencies is/are near a higher frequency end of said passband.

45. A loudspeaker system according to claim 39 wherein said enclosure includes backwave barrier means adapted to exclude from said confined space sound generated from a side of said transducer opposing said space.

46. A loudspeaker system according to claim 45 wherein said backwave barrier means includes an acoustically leaky element.

47. A loudspeaker system according to claim 45 wherein said backwave barrier means includes a sealed or acoustically leaky cavity built into a motor vehicle.

48. A loudspeaker system according to claim 47 wherein said backwave barrier means includes a wall of a trunk of said vehicle.

49. A loudspeaker system according to claim 47 wherein said backwave barrier means includes a rear parcel shelf of said vehicle.

50. A loudspeaker system according to claim 46 wherein said leaky element causes at least partial sound field cancellation outside of said confined space.

51. A loudspeaker system according to claim 39 wherein said equalizing means is adapted to attenuate said rising response at least at said selected frequency or frequencies.

52. A loudspeaker system according to claim 39 wherein said equalizing means includes a two pole filter.

53. A loudspeaker system according to claim 39 wherein such equalizing means is included with an inverter amplifier combination used for driving said electro-acoustic transducer.

54. A loudspeaker system according to claim 42 wherein said first acoustic filter interacts with a first side of said electro-acoustic transducer and including a second acoustic filter adapted to interact with a second side of said electro-acoustic transducer opposing said first side.

55. A loudspeaker system according to claim 54 wherein said second acoustic filter is adapted to modify phase and/or amplitude of a backwave generated by said electro-acoustic transducer.

56. A loudspeaker system according to claim 54 wherein said second acoustic-filter is adapted to enhance cancellation of a sound field attributable to said system that is external to said space.

57. A method of extending output of a loudspeaker system suitable for a confined space, said method including:
providing an electro-acoustic transducer having a relatively low value of Qt, wherein Qt denotes total quality factor of resonant behaviour of said electro-acoustic transducer including electrical and mechanical quality factors;
providing an enclosure for said electro-acoustic transducer, said enclosure having a second order topology which is naturally inclined to produce a rising acoustic response for said system at a second order rate;
interfacing said enclosure to said confined space to modify said rising response relative to said second order rate such that said response is attenuated relative to said second order rate but is accentuated relative to a substantially flat response within a substantial part of a passband of said system, said accentuation being most significant at a selected frequency or frequencies near a high end of said passband, said interfacing being further arranged to filter harmonics out of said acoustic response to reduce distortion; and
electrically equalizing said rising response to be substantially flat overall and to provide extended dynamic headroom at least at said selected frequency or frequencies.

58. A method according to claim 57 wherein said second order rate is substantially 12 dB/octave and said attenuated response is not more than substantially 9 dB/octave.

59. A method according to claim 57 wherein said attenuated response is substantially 6 dB/octave.

60. A method according to claim 57 wherein said interfacing is performed via a first acoustic filter.

61. A method according to claim 60 wherein said first acoustic filter includes a helmholtz resonator.

62. A method according to claim 57 wherein said selected frequency or frequencies is/are near a higher frequency end of said passband.

63. A method according to claim 57 wherein said enclosure includes backwave barrier means adapted to exclude from said confined space sound generated from a side of said transducer opposing said space.

64. A method according to claim 63 wherein said backwave barrier means includes an acoustically leaky element.

65. A method according to claim 63 wherein said backwave barrier means includes a sealed or acoustically leaky cavity built into a motor vehicle.

66. A method according to claim 65 wherein said backwave barrier means includes a wall of a trunk of said vehicle.

67. A method according to claim 65 wherein said backwave barrier means includes a rear parcel shelf of said vehicle.

68. A method according to claim 64 including utilizing said leaky element to at least partially cancel a sound field attributable to said system that is external to said confined space.

69. A method according to claim 57 wherein said equalizing is adapted to attenuate said rising response at least at said selected frequency or frequencies.

70. A method according to claim 57 wherein said equalizing is performed via a two pole filter.

71. A method according to claim 57 wherein such equalizing is performed by means included with an inverter amplifier combination used for driving said electro-acoustic transducer.

72. A method according to claim 60 wherein said first acoustic filter interacts with a first side of said electro-acoustic transducer and including providing a second acoustic filter adapted to interact with a second side of said electro-acoustic transducer opposing said first side.

73. A method according to claim 72 wherein said second acoustic filter is adapted to modify phase and/or amplitude of a backwave generated by said electro-acoustic transducer.

74. A method according to claim 72 wherein said second acoustic-filter is adapted to enhance cancellation of a sound field attributable to said system that is external to said space.
